(19) United States
(12) Patent Application Publication
(10) Pub. No.: US 2007/0163674 A1
(43) Pub. Date: Jul. 19, 2007

(54) Convertible top drive

(76) Inventors: Markus Kustner, Ludwigsburg (DE); Klaus Kleemann, Birkenfeld (DE); Detlev Ranft, Ettlingen (DE); Beatrix Gross, Stuttgart (DE)

Correspondence Address: WALTER A. HACKLER, Ph.D;PATENT LAW OFFICE, SUITE B, 2372 S.E. BRISTOL STREET, NEWPORT BEACH, CA, 92660-0755, US

(21) Appl. No.: 11/644,516

(22) Filed: Dec. 22, 2006

(30) Foreign Application Priority Data
Dec. 24, 2005 (DE) 10 2005 062 301.8

(51) Int. Cl. B27L 7/00

(52) U.S. Cl. 144/194

(57) ABSTRACT

A convertible top drive comprises a gearing arrangement for driving a driven shaft (40) which is connected to the convertible top linkage via a drive lever. The driven shaft (40) and the drive lever include a toothing, and a cam and groove for pre-orientation, which couple the driven shaft (40) and the drive lever without play in such a manner that they cannot rotate relative to each other.

### BACKGROUND

The invention concerns a convertible top drive for a vehicle, comprising a gearing arrangement for driving a driven shaft which is connected to a convertible top linkage via a drive lever.

A convertible top drive of this type is disclosed e.g. in DE 19909489 A1.

It is the underlying purpose of the invention to improve the coupling between the driven shaft and a drive lever of the convertible top drive, which improves the power transmission on a permanent basis.

### SUMMARY OF THE INVENTION

A convertible top drive in accordance with the present invention includes a driven shaft and a drive lever having toothing for coupling the driven shaft and the drive lever without play such that they cannot rotate relative to each other. The toothing, in particular a Hirth toothing, may be advantageously integrated on a front side of the driven shaft and the drive lever.

### BRIEF DESCRIPTION OF THE DRAWINGS

The figures of the schematic drawing show a preferred embodiment of the invention, which is explained with reference to the figures.

FIG. 1 shows a perspective view of the driven shaft;

FIG. 2 shows a perspective view of the drive lever; and

FIG. 3 shows a perspective view of the conventional convertible top drive (prior art).

### DETAILED DESCRIPTION

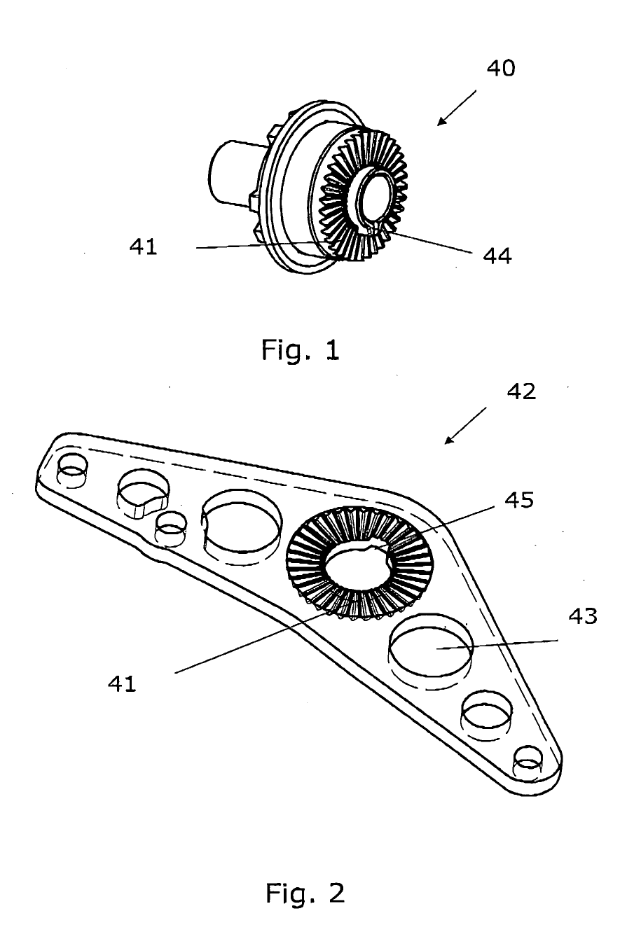

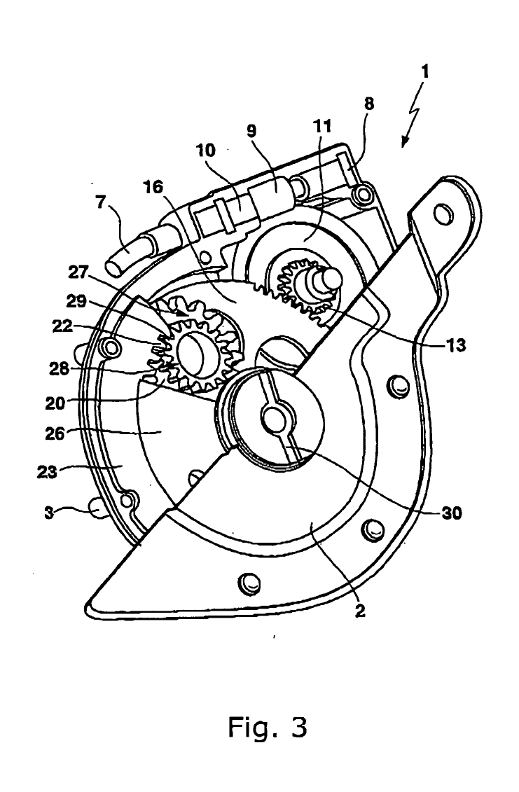

FIG. 1 shows a driven shaft 40 which corresponds substantially to the driven shaft 30 of prior art (FIG. 3). The driven shaft 40 is driven in the same fashion by the planet gear. FIG. 1 shows that the driven shaft 40 has a so-called Hirth toothing 41 on its front side and a cam 44 for pre-orientation.

FIG. 2 shows a drive lever 42 that can be driven by the driven shaft 40, and has bores 43 for connecting the drive lever 42 to a convertible top linkage. The drive lever 42 also has a toothing 41 and a groove for pre-orientation 45 in order to provide a positive connection to the driven shaft.

In accordance with FIG. 3, a convertible top drive 1 comprises a housing lid 2 to which the essential drive elements of the convertible top drive 1 are mounted and protected towards the outside by a housing 3. A flexible drive shaft 7 is guided within a jacket, which can be driven by an electromotor. A worm 9 is disposed between a first bearing shell and a further, second bearing shell, and is connected to the drive shaft. The worm 9 engages a worm gear. The worm gear is connected to a toothed shaft whose teeth engage in the teeth of a spur wheel. The spur wheel is connected to a sun wheel which is part of a planet gear. The gearing reduces the rotation of the drive shaft 7 into a rotation of the driven shaft 30 and increases the torque.

1. Convertible top drive comprising a gearing arrangement for driving a driven shaft (40) which is connected to a convertible top linkage via a drive lever (41), the driven shaft (40) and the drive lever (41), have a toothing enabling the driven shaft (40) and the drive lever (41) to be coupled to each other without play in such a manner that they cannot rotate relative to each other.

2. Convertible top drive according to claim 1, wherein the toothing comprises Hirth toothing.

3. Convertible top drive according to claim 1, further comprises one or more cams (44) and grooves (45) for pre-orientation of the position of a element (41) to be driven relative to the driven shaft (40).
